(19) United States
(12) Patent Application Publication
(10) Pub. No.: US 2026/0024431 A1
(43) Pub. Date: Jan. 22, 2026

(54) OPTIMIZED SUPERVISION RATE FOR WIRELESS INTRUSION DETECTORS

(71) Applicant: Honeywell International Inc., Charlotte, NC (US)

(72) Inventors: Eldhose K. George, Kerala (IN); Ruban S, Tamilnadu (IN); Jijesh Ganapathy, Tamilnadu (IN)

(21) Appl. No.: 18/778,731

(22) Filed: Jul. 19, 2024

(51) Int. Cl. G08B 29/12

(52) U.S. Cl. CPC G08B 29/12

(57) ABSTRACT

A first sensor periodically communicates at a first supervisory rate and a second sensor periodically communicates at a second supervisory rate. A first tamper alarm associated with the first sensor is issued when the first supervisory signals are not received from the first sensor at the first supervisory rate. A second tamper alarm associated with the second wireless security sensor is issued when the second supervisory signals are not received from the second sensor at the second supervisory rate. The first supervisory signals and the second supervisory signals are scheduled in a manner that helps detect tampering with one or more of the first and/or second security sensors in an expedited manner.

### TECHNICAL FIELD

The present disclosure relates generally to security systems. More particularly, the present disclosure relates to security systems with wireless sensors.

### BACKGROUND

A number of security systems employ security sensors that are disposed about a facility that is being protected by the security system. In some cases, individual security sensors may be susceptible to being tampered with in an attempt to break into a facility. If individual security sensors only infrequently check-in with a security panel, it is possible for the security system to not report an alarm condition for an extended period of time, especially when the security system must confirm an alarm condition detected by a security sensor before the security system reports the detected alarm condition. Confirmation of the alarm conditions detected by the security sensors may be desirable to reduce false alarms and thus increase the robustness of the security system. When so provided, if a security sensor is tampered with and goes off-line before a detected alarm condition can be confirmed by the security system, the detected alarm condition may go unreported until, for example, the corresponding security sensor misses its next infrequent check-in time. What would be desired are methods and systems for scheduling check in times of the security sensors to help detect tampering with one or more of the security sensors in an expedited manner.

### SUMMARY

The present disclosure relates generally to security systems and more particularly to scheduling supervision times for wireless security sensors within a security system. An example may be found in a method for operating a security system controller. The illustrative method includes scheduling transmission of first supervisory signals from a first wireless security sensor to the security system controller (e.g. security panel) at reoccurring times at a first supervisory rate. The first supervisory signals when received by the security system controller repeatedly confirms to the security system controller that the first wireless security sensor remains operatively coupled to the security system controller. The illustrative method includes scheduling transmission of second supervisory signals from a second wireless security sensor to the security system controller at reoccurring times at a second supervisory rate. The second supervisory signals when received by the security system controller repeatedly confirms to the security system controller that the second wireless security sensor remains operatively coupled to the security system controller.

A first security sensor alarm is received from the first wireless security sensor indicating an alarm condition detected by the first wireless security sensor. A second security sensor alarm is received from the first wireless security sensor within a predetermined period of time of the first security sensor alarm, the second security sensor alarm confirming the alarm condition. An alarm condition detection alarm is issued from the security system controller after receiving the second security sensor alarm from the first wireless security sensor within the predetermined period of time confirming the alarm condition.

In some cases, each of the first supervisory signals are scheduled to be temporally offset from the second supervisory signals. A first tamper alarm associated with the first wireless security sensor is issued when the first supervisory signals are not received from the first wireless security sensor at the first supervisory rate. A second tamper alarm associated with the second wireless security sensor is issued when the second supervisory signals are not received from the second wireless security sensor at the second supervisory rate.

Because the first supervisory signals are scheduled to be temporally offset from the second supervisory signals, if an intruder were to successfully disable the first wireless security sensor and the second wireless security sensor after one of the first supervisory signals is transmitted by the first wireless security sensor but before the temporarily offset second supervisory signal is transmitted by the second wireless security sensor, such disabling of the second wireless security sensor would be detected by the security system controller when the subsequent temporarily offset second supervisory signal of the second wireless security sensor is not received as scheduled. In contrast, if the first supervisory signals and the second supervisory signals were substantially aligned in time, then such disabling of the first and/or second wireless security sensors would not be detected by the security system controller until the next scheduled time of the first supervisory signals and the second supervisory signals, which could be a significant length of time. When a plurality of wireless security sensors are operatively coupled to the security system controller, the supervisory signals from each of the plurality of wireless security sensors may be transmitted according to a predetermined periodic schedule, with the predetermined periodic schedule of each of the plurality of wireless security sensors temporarily offset from the others, resulting in a staggered transmission of the supervisory signals from the plurality of wireless security sensors. In some cases, the predetermined periodic schedules of the plurality of wireless security sensors may be temporarily offset from the others such that the supervisory signals from the plurality of wireless security sensors are temporally distributed across a time period that corresponds to at least a majority of the period of the predetermined periodic schedule, but this is not required.

Another example may be found in a method for operating a security system controller. The illustrative method includes receiving security sensor alarms from each of a plurality of security sensors in a region of a facility, wherein each security sensor alarm is received when an alarm condition is detected by a corresponding one of the plurality of security sensors. The method includes confirming one or more of the received security sensor alarms when the corresponding security sensor again detects the alarm condition in the region of the facility within a predetermined period of time, resulting in one or more confirmed alarm conditions. The security system controller issues an alarm for each of the one or more confirmed alarm conditions. Supervisory signals are repeatedly received from each of the plurality of security sensors. A supervisory signal is scheduled for transmission from each of the plurality of security sensors during each of a plurality of sequential time intervals, wherein for each sequential time interval, the transmission of the supervisory signals from each of the plurality of security sensors are spaced from one another in time along the corresponding sequential time interval.

Another example may be found in a method for operating a security system controller. The illustrative method includes receiving security sensor alarms from each of a plurality of security sensors in a region of a facility, wherein each security sensor alarm is received when an alarm condition is detected by the corresponding one of the plurality of security sensors, and confirming one or more of the received security sensor alarms when the corresponding security sensor again detects the alarm condition in the region of the facility within a predetermined period of time, resulting in one or more confirmed alarm conditions. The security system controller issues an alarm for each of the one or more confirmed alarm conditions. Supervisory signals are repeatedly received from each of the plurality of security sensors. The security system controller has an armed state and a disarmed state, and when the security system controller is in the armed state, the security system controller increases the supervisory rate at which the supervisory signals are to be received from at least some of the plurality of security sensors relative to when the security system controller is in the disarmed state.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative security system;

FIG. 2 is a schematic block diagram showing a logical grouping of security sensors;

FIGS. 3A and 3B are flow diagrams that together show an illustrative method for operating a security system controller forming part of the illustrative security system of FIG. 1;

FIG. 4 is a flow diagram showing an illustrative method for operating a security system controller forming part of the illustrative security system of FIG. 1; and

FIG. 5 is an illustrative method for operating a security system controller forming part of the illustrative security system of FIG. 1.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

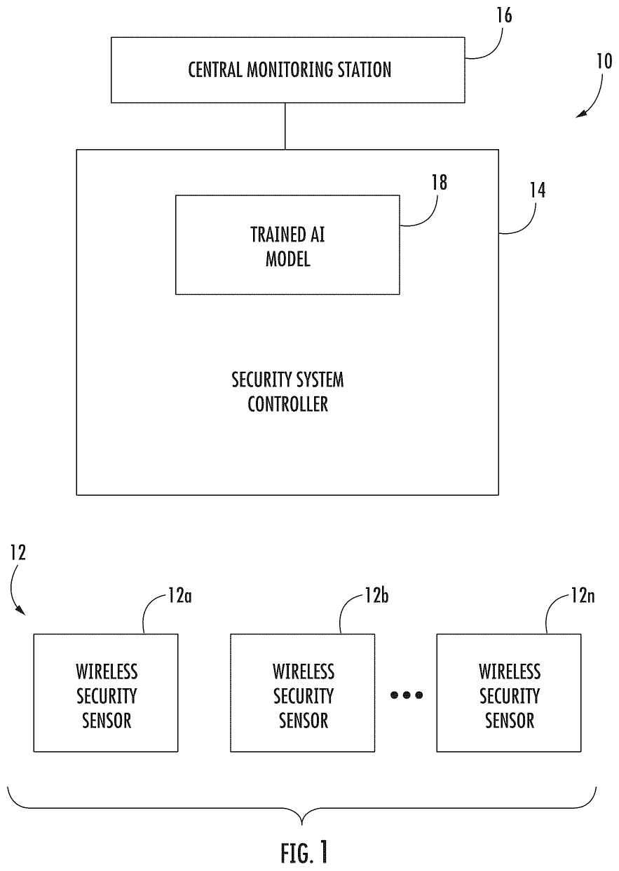

FIG. 1 is a schematic block diagram showing an illustrative security system 10.

The illustrative security system 10 may include a number of wireless security sensors 12, individually labeled as 12a, 12b and through 12n. The security system 10 may include tens, hundreds or even thousands of wireless security sensors 12. The security system 10 may include a variety of different types of wireless security sensors 12, such as window open sensors, door open sensors, glass break detectors, motion detectors, fire sensors, smoke sensors, gas sensors and the like. The wireless security sensors 12 may be battery-powered. In some cases, each of the wireless security sensors 12 may communicate with a security system controller 14 over any of a variety of different wireless communication protocols.

In some instances, the security system controller 14 or at least some features thereof may be provided within one or more edge controllers. In some cases, the security system controller 14 may be provided within an on-site security panel, for example. In some cases, the security system controller 14 or at least some features thereof may be provided within one or more remote or cloud-based servers, for example. The security system controller 14 may be configured to receive signals from the wireless security sensors 12 that may indicate a potential issue that would cause the security system controller 14 to output an alarm or other alert.

In the example shown, the security system controller 14 communicates with a central monitoring station 16. In some instances, the central monitoring station 16 may be configured to monitor for alarms and other alerts from a number of different security systems 10 within a number of different facilities. The central monitoring station 16 may be configured to display a dashboard displaying various alarms and other alerts so that a person is able to quickly see and ascertain what is happening in each of the facilities, for example. In some instances, the security system controller 14 may include the central monitoring station 16.

In some instances, the security system controller 14 may include a trained AI model 18. In some cases, the trained AI model 18 may be configured to make predictions regarding future time periods in which a particular wireless security sensor 12 is predicted to detect a number of confirmed alarm conditions that is above a threshold. In some cases, when this happens, the security system controller 14 may be configured to set a first supervisory rate to an increased supervisory rate during the future time period. In some cases, the trained AI model 18 may be manifested within the security system controller 14. In some instances, the trained AI model 18 may reside in the cloud, and may be accessed by the security system controller 14.

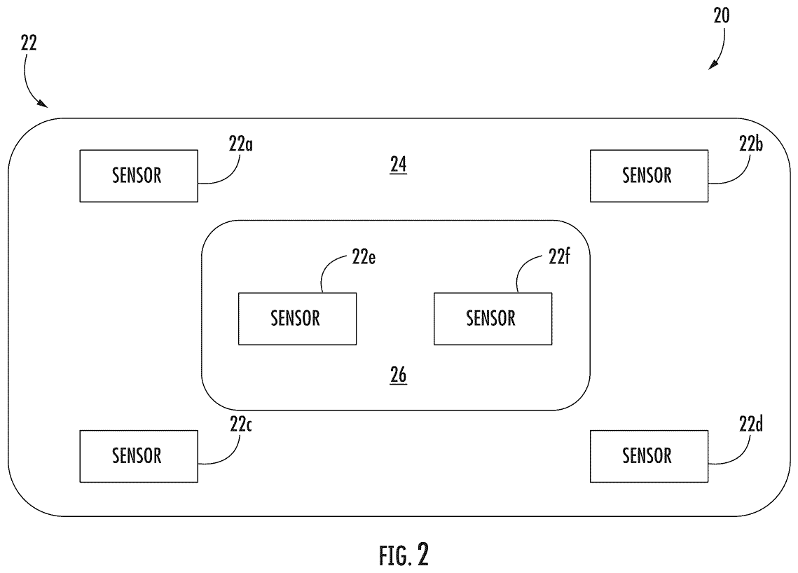

FIG. 2 is a schematic block diagram showing a facility or part of a facility 20 and a number of sensors 22 that are laid out within the facility 20. The sensors 22, which are individually labeled as 22a, 22b, 22c, 22d, 22e and 22f, may be considered as representing the sensors 12 shown in FIG. 1. The facility 20 may include a region 24 and a region 26. While only two regions 24 and 26 are shown, in some cases the facility 20 may include three or more distinct regions or zones.

The sensors 22 within the region 24, such as the sensors 22a, 22b, 22c and 22d, may be considered as being within a group of sensors that has a relatively higher risk of being tampered with. In some cases, the region 24 may be considered as representing a perimeter of the facility 20, and thus the sensors 22a, 22b, 22c and 22d may be among the first sensor(s) 20 that would be targeted by someone attempting to infiltrate the facility 20. The sensors 22a, 22b, 22c and 22d may include, for example, door sensors, window sensors, glass break sensors and motion sensors. The sensors 22 within the region 26, such as the sensors 22e and 22f, may be considered as being within a group of sensors that have a relatively lower risk of being tampered with. In some cases, the region 26 may be considered as representing an interior of the facility 20, and thus the sensors 22e and 22f likely would not be tampered with at all, or at least not until after one or more of the sensors 22a, 22b, 22c or 22d would be tampered with. In some cases, as will be discussed, the relative risk for a particular sensor 22 to be tampered with may influence how often a particular sensor 22 is checked in with (e.g. via a supervisory signal).

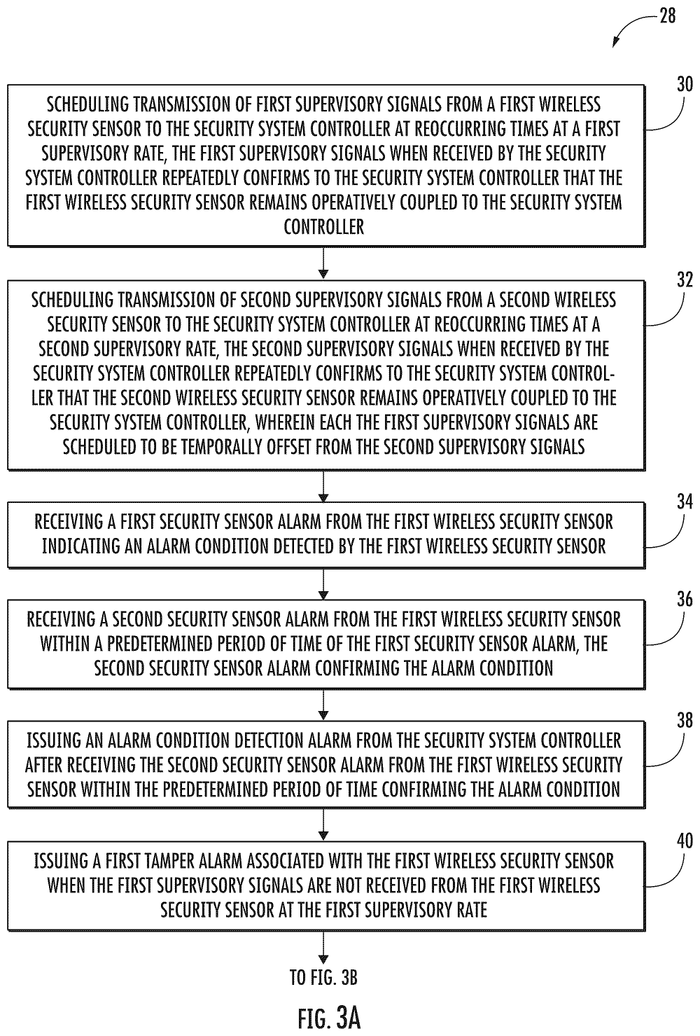

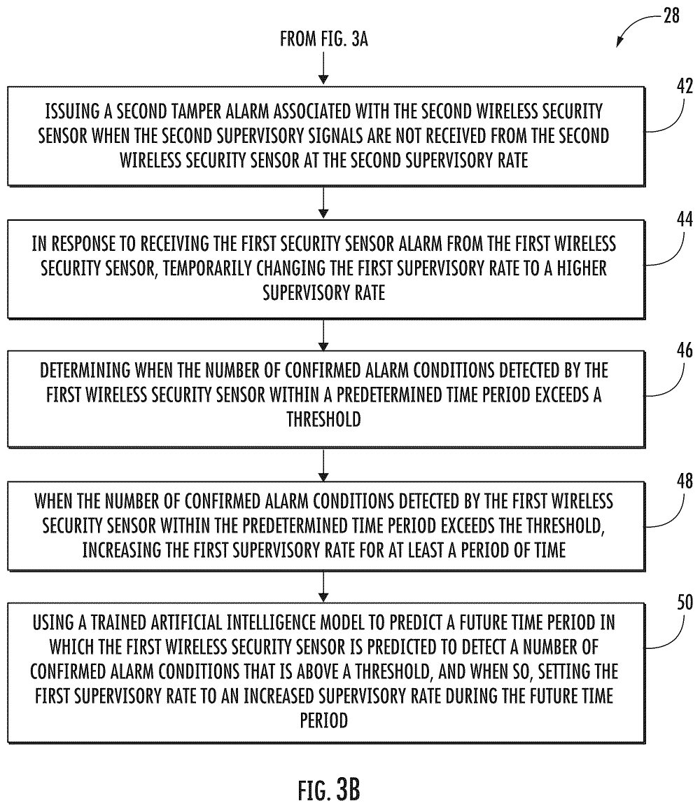

FIGS. 3A and 3B are flow diagrams that together show an illustrative method 28 for operating a security system controller (such as the security system controller 14). The method 28 includes scheduling transmission of first supervisory signals from a first wireless security sensor (such as one of the wireless security sensors 12) to the security system controller at reoccurring times at a first supervisory rate, the first supervisory signals when received by the security system controller repeatedly confirms to the security system controller that the first wireless security sensor remains operatively coupled to the security system controller, as indicated at block 30. Transmission of second supervisory signals from a second wireless security sensor to the security system controller are scheduled at reoccurring times at a second supervisory rate, the second supervisory signals when received by the security system controller repeatedly confirms to the security system controller that the second wireless security sensor remains operatively coupled to the security system controller, wherein each the first supervisory signals are scheduled to be temporarily offset from the second supervisory signals, as indicated at block 32.

In some cases, the first supervisory rate associated with the first wireless security sensor may be the same as the second supervisory rate that is assigned to the second wireless security sensor. In some cases, the first supervisory signals may be scheduled to be temporally offset from the second supervisory signals by a predetermined temporal offset amount. In some cases, the first supervisory rate associated with the first wireless security sensor may be different from the second supervisory rate that is assigned to the second wireless security sensor.

In one example, when a plurality of wireless security sensors are provided, a supervision check time interval may be set at 2 hours. Instead of assigning supervision check in times at or about the same time for all the wireless security sensors (e.g. 12 AM, 2 AM, 4 AM, 6 AM and so on), the supervision check in times may be temporally offset and distributed among the plurality of wireless security sensor, either sequentially or randomly. For example, Sensor-1 may have check-in times at 12 AM, 2 AM, 4 AM, 6 AM etc., Sensor-2 may have check in times at 12.15 AM, 2.15 AM, 4.15 AM, 6.15 AM etc., Sensor-3 may have check in times offset at 12.30 AM, 2.30 AM, 4.30 AM, 6.30 AM, and so on. In some cases, these intervals and the temporal offsets can be set by the installer of the security system based on site conditions. This solution has no impact in the battery life of the wireless security sensors.

Because the first supervisory signals are scheduled to be temporally offset from the second supervisory signals, if an intruder were to successfully disable the first wireless security sensor and the second wireless security sensor after one of the first supervisory signals is transmitted by the first wireless security sensor but before the temporarily offset second supervisory signal is transmitted by the second wireless security sensor, such disabling of the second wireless security sensor would be detected by the security system controller 14 when the subsequent temporarily offset second supervisory signal of the second wireless security sensor is not received as scheduled. In contrast, if the first supervisory signals and the second supervisory signals were substantially aligned in time, then such disabling of the first and/or second wireless security sensors may not be detected by the security system controller 14 until the next scheduled time of the first supervisory signals and the second supervisory signals, which could be a significant length of time. When a plurality of wireless security sensors 12 are operatively coupled to the security system controller 14, the supervisory signals from each of the plurality of wireless security sensors 12 may be transmitted according to a predetermined periodic schedule, with the predetermined periodic schedule of each of the plurality of wireless security sensors 12 temporarily offset from the others, resulting in a staggered transmission of the supervisory signals from the plurality of wireless security sensors 12. In some cases, the predetermined periodic schedules of the plurality of wireless security sensors 12 may be temporarily offset from the others such that the supervisory signals from the plurality of wireless security sensors 12 are temporally distributed across a time period that corresponds to at least a majority of the period of the predetermined periodic schedule, but this is not required.

In some cases, the first wireless security sensor and the second wireless security sensor may monitor a common region of a facility. The security system controller 14 may have an armed state and a disarmed state, and wherein the security system controller 14 may set each of the first supervisory rate and the second supervisory rate to a higher supervisory rate when the security system controller 14 is in the armed state than when the security system controller 14 is in the disarmed state. In some cases, the reoccurring times that the first supervisory signals are transmitted from the first wireless security sensor to the security system controller 14 may alternate with the reoccurring times that the second supervisory signals are transmitted from the second wireless security sensor to the security system controller 14. In some cases, the first wireless security sensor may be assigned to a first sensor group associated with security sensors 22a-22d that are identified as having a higher risk of sensor tampering, and the second wireless security sensor may be assigned to a second sensor group associated with security sensors 22e-22f that are identified as having a lower risk of sensor tampering relative to the security sensors assigned to the first sensor group. The supervisory rate for the security sensors associated with the first sensor group, including the first wireless security sensor, may be set higher than the supervisory rate for the security sensors associated with the second sensor group, including the second wireless security sensor.

A first security sensor alarm is received from the first wireless security sensor indicating an alarm condition detected by the first wireless security sensor, as indicated at block 34. A second security sensor alarm is received from the first wireless security sensor within a predetermined period of time of the first security sensor alarm, the second security sensor alarm confirming the alarm condition, as indicated at block 36. An alarm condition detection alarm is issued from the security system controller 14 after receiving the second security sensor alarm from the first wireless security sensor within the predetermined period of time confirming the alarm condition, as indicated at block 38. A first tamper alarm associated with the first wireless security sensor is issued when the first supervisory signals are not received from the first wireless security sensor at the first supervisory rate, as indicated at block 40. Continuing on FIG. 3B, a second tamper alarm associated with the second wireless security sensor is issued when the second supervisory signals are not received from the second wireless security sensor at the second supervisory rate, as indicated at block 42.

In some instances, the method 28 may include, in response to receiving the first security sensor alarm from the first wireless security sensor, temporarily changing the first supervisory rate to a higher supervisory rate, as indicated at block 44. In some cases, a determination may be made as to when the number of confirmed alarm conditions detected by the first wireless security sensor within a predetermined time period exceeds a threshold, as indicated at block 46. When the number of confirmed alarm conditions detected by the first wireless security sensor within the predetermined time period exceeds the threshold, the method 28 may include increasing the first supervisory rate for at least a period of time, as indicated at block 48. In some cases, the method 28 may include using a trained artificial intelligence model to predict a future time period in which the first wireless security sensor is predicted to detect a number of confirmed alarm conditions that is above a threshold, and when so, setting the first supervisory rate to an increased supervisory rate during the future time period, as indicated at block 50.

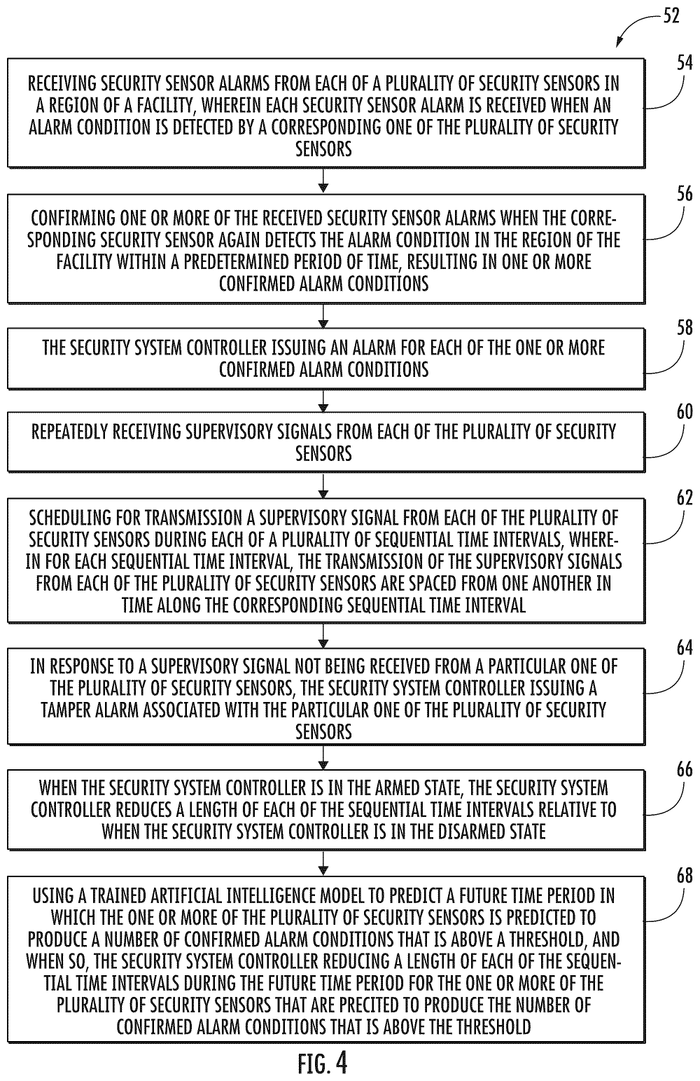

FIG. 4A is a flow diagram showing an illustrative method 52 for operating a security system controller (such as the security system controller 14). The method 52 includes receiving security sensor alarms from each of a plurality of security sensors 12 in a region of a facility, wherein each security sensor alarm is received when an alarm condition is detected by a corresponding one of the plurality of security sensors, as indicated at block 54. One or more of the received security sensor alarms are confirmed when the corresponding security sensor again detects the alarm condition in the region of the facility within a predetermined period of time, resulting in one or more confirmed alarm conditions, as indicated at block 56. The security system controller 14 issues an alarm for each of the one or more confirmed alarm conditions, as indicated at block 58.

Supervisory signals are repeatedly received from each of the plurality of security sensors 12, as indicated at block 60. A supervisory signal from each of the plurality of security sensors 12 is scheduled for transmission during each of a plurality of sequential time intervals, wherein for each sequential time interval, the transmission of the supervisory signals from each of the plurality of security sensors 12 are spaced from one another in time along the corresponding sequential time interval, as indicated at block 62. In some instances, the transmission of the supervisory signals from each of the plurality of security sensors 12 may be distributed randomly in time along the corresponding sequential time interval. In some cases, the transmission of the supervisory signals from each of the plurality of security sensors may be distributed in a predetermined sequence along the corresponding sequential time interval. These are just examples.

In some cases, and in response to a supervisory signal not being received from a particular one of the plurality of security sensors 12, the security system controller 14 may issue a tamper alarm associated with the particular one of the plurality of security sensors 12, as indicated at block 64. In some cases, the security system controller 14 may have an armed state and a disarmed state, and when the security system controller 14 is in the armed state, the security system controller 14 may reduce a length of each of the sequential time intervals relative to when the security system controller 14 is in the disarmed state, as indicated at block 66.

In some cases, one or more of the plurality of security sensors 12 may be assigned to a first sensor group associated with security sensors 22a-22d that are identified as having a higher risk of sensor tampering, and one or more other of the plurality of security sensors 12 may be assigned to a second sensor group associated with security sensors 22e-22f that are identified as having a lower risk of sensor tampering relative to the security sensors assigned to the first sensor group, and wherein the security system controller 14 may reduce a length of each of the sequential time intervals for the one or more of the plurality of security sensors 12 that are assigned to the first sensor group relative to the supervisory rate of the one or more other of the plurality of security sensors 12 that are assigned to a second sensor group.

In some cases, the method 28 may include using a trained artificial intelligence model 18 to predict a future time period in which the one or more of the plurality of security sensors 12 is predicted to produce a number of confirmed alarm conditions that is above a threshold, and when so, the security system controller 14 reducing a length of each of the sequential time intervals during the future time period for the one or more of the plurality of security sensors 12 that are precited to produce the number of confirmed alarm conditions that is above the threshold, as indicated at block 68.

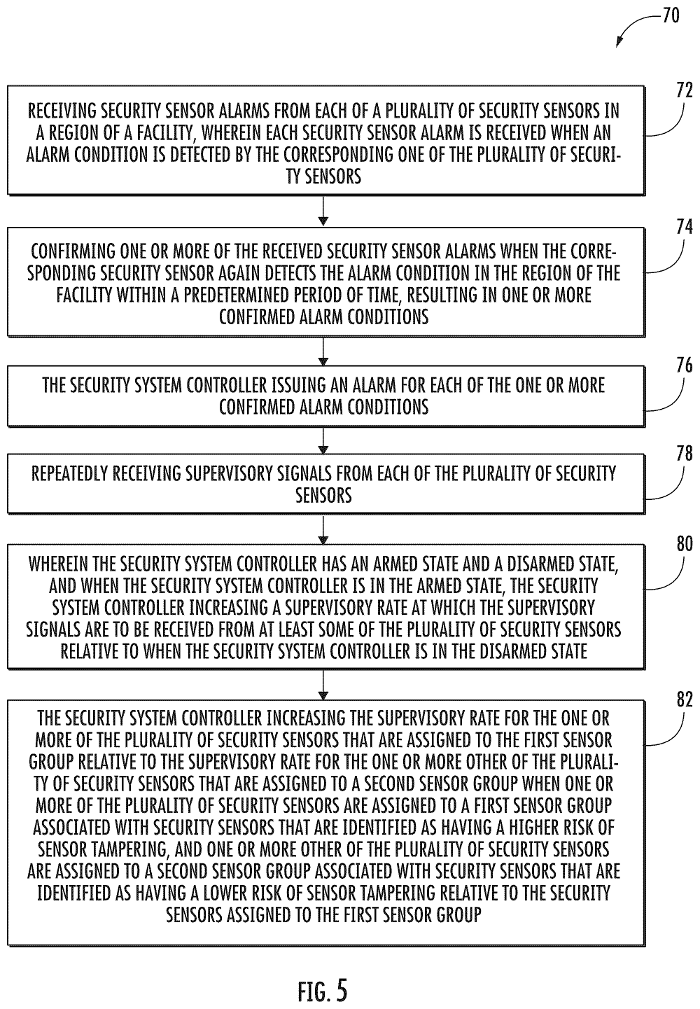

FIG. 5 is a flow diagram showing an illustrative method 70 for operating a security system controller (such as the security system controller 14). The method 70 includes receiving security sensor alarms from each of a plurality of security sensors 12 in a region of a facility, wherein each security sensor alarm is received when an alarm condition is detected by the corresponding one of the plurality of security sensors, as indicated at block 72. One or more of the received security sensor alarms are confirmed when the corresponding security sensor again detects the alarm condition in the region of the facility within a predetermined period of time, resulting in one or more confirmed alarm conditions, as indicated at block 74. The security system controller 14 issues an alarm for each of the one or more confirmed alarm conditions, as indicated at block 76. Supervisory signals are repeatedly received from each of the plurality of security sensors 12, as indicated at block 78. The security system controller 14 has an armed state and a disarmed state, and when the security system controller 14 is in the armed state, the security system controller 14 increases a supervisory rate at which the supervisory signals are to be received from at least some of the plurality of security sensors 12 relative to when the security system controller 14 is in the disarmed state, as indicated at block 80.

In some cases, one or more of the plurality of security sensors 12 may be assigned to a first sensor group associated with security sensors 22a-22d that are identified as having a higher risk of sensor tampering, and one or more other of the plurality of security sensors 12 may be assigned to a second sensor group associated with security sensors 22e-22f that are identified as having a lower risk of sensor tampering relative to the security sensors assigned to the first sensor group. The security system controller 14 may increase the supervisory rate for the one or more of the plurality of security sensors 12 that are assigned to the first sensor group relative to the supervisory rate for the one or more other of the plurality of security sensors 12 that are assigned to a second sensor group, as indicated at block 82.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for operating a security system controller, the method comprising:
scheduling transmission of first supervisory signals from a first wireless security sensor to the security system controller at reoccurring times at a first supervisory rate, the first supervisory signals when received by the security system controller repeatedly confirms to the security system controller that the first wireless security sensor remains operatively coupled to the security system controller;
scheduling transmission of second supervisory signals from a second wireless security sensor to the security system controller at reoccurring times at a second supervisory rate, the second supervisory signals when received by the security system controller repeatedly confirms to the security system controller that the second wireless security sensor remains operatively coupled to the security system controller;
wherein each the first supervisory signals are scheduled to be temporally offset from the second supervisory signals;
receiving a first security sensor alarm from the first wireless security sensor indicating an alarm condition detected by the first wireless security sensor;
receiving a second security sensor alarm from the first wireless security sensor within a predetermined period of time of the first security sensor alarm, the second security sensor alarm confirming the alarm condition;
issuing an alarm condition detection alarm from the security system controller after receiving the second security sensor alarm from the first wireless security sensor within the predetermined period of time confirming the alarm condition;
issuing a first tamper alarm associated with the first wireless security sensor when the first supervisory signals are not received from the first wireless security sensor at the first supervisory rate; and
issuing a second tamper alarm associated with the second wireless security sensor when the second supervisory signals are not received from the second wireless security sensor at the second supervisory rate.

2. The method of claim 1, wherein the first supervisory rate associated with the first wireless security sensor is the same as the second supervisory rate that is assigned to the second wireless security sensor.

3. The method of claim 2, wherein the first supervisory signals are scheduled to be temporally offset from the second supervisory signals by a predetermined temporal offset amount.

4. The method of claim 1, wherein the first supervisory rate associated with the first wireless security sensor is different from the second supervisory rate that is assigned to the second wireless security sensor.

5. The method of claim 1, comprising:
in response to receiving the first security sensor alarm from the first wireless security sensor, temporarily changing the first supervisory rate to a higher supervisory rate.

6. The method of claim 1, wherein the first wireless security sensor and the second wireless security sensor monitor a common region of a facility.

7. The method of claim 1, wherein the security system controller has an armed state and a disarmed state, and wherein the security system controller sets each of the first supervisory rate and the second supervisory rate to a higher supervisory rate when the security system controller is in the armed state than when the security system controller is in the disarmed state.

8. The method of claim 1, wherein the reoccurring times that the first supervisory signals are transmitted from the first wireless security sensor to the security system controller alternate with the reoccurring times that the second supervisory signals are transmitted from the second wireless security sensor to the security system controller.

9. The method of claim 1, wherein the first wireless security sensor is assigned to a first sensor group associated with security sensors that are identified as having a higher risk of sensor tampering, and the second wireless security sensor is assigned to a second sensor group associated with security sensors that are identified as having a lower risk of sensor tampering relative to the security sensors assigned to the first sensor group, and wherein the supervisory rate for the security sensors associated with the first sensor group, including the first wireless security sensor, is set higher than the supervisory rate for the security sensors associated with the second sensor group, including the second wireless security sensor.

10. The method of claim 1, comprising:
determining when the number of confirmed alarm conditions detected by the first wireless security sensor within a predetermined time period exceeds a threshold; and
when the number of confirmed alarm conditions detected by the first wireless security sensor within the predetermined time period exceeds the threshold, increasing the first supervisory rate for at least a period of time.

11. The method of claim 1, comprising:
using a trained artificial intelligence model to predict a future time period in which the first wireless security sensor is predicted to detect a number of confirmed alarm conditions that is above a threshold, and when so, setting the first supervisory rate to an increased supervisory rate during the future time period.

12. A method for operating a security system controller, the method comprising:
receiving security sensor alarms from each of a plurality of security sensors in a region of a facility, wherein each security sensor alarm is received when an alarm condition is detected by a corresponding one of the plurality of security sensors;
confirming one or more of the received security sensor alarms when the corresponding security sensor again detects the alarm condition in the region of the facility within a predetermined period of time, resulting in one or more confirmed alarm conditions;
the security system controller issuing an alarm for each of the one or more confirmed alarm conditions;
repeatedly receiving supervisory signals from each of the plurality of security sensors; and
scheduling for transmission a supervisory signal from each of the plurality of security sensors during each of a plurality of sequential time intervals, wherein for each sequential time interval, the transmission of the supervisory signals from each of the plurality of security sensors are spaced from one another in time along the corresponding sequential time interval.

13. The method of claim 12, wherein the transmission of the supervisory signals from each of the plurality of security sensors are distributed randomly in time along the corresponding sequential time interval.

14. The method of claim 12, wherein the transmission of the supervisory signals from each of the plurality of security sensors are distributed in a predetermined sequence along the corresponding sequential time interval.

15. The method of claim 12, comprising:
wherein in response to a supervisory signal not being received from a particular one of the plurality of security sensors, the security system controller issuing a tamper alarm associated with the particular one of the plurality of security sensors.

16. The method of claim 12, wherein the security system controller has an armed state and a disarmed state, and when the security system controller is in the armed state, the security system controller reduces a length of each of the sequential time intervals relative to when the security system controller is in the disarmed state.

17. The method of claim 12, wherein one or more of the plurality of security sensors are assigned to a first sensor group associated with security sensors that are identified as having a higher risk of sensor tampering, and one or more other of the plurality of security sensors are assigned to a second sensor group associated with security sensors that are identified as having a lower risk of sensor tampering relative to the security sensors assigned to the first sensor group, and wherein the security system controller reduces a length of each of the sequential time intervals for the one or more of the plurality of security sensors that are assigned to the first sensor group relative to the supervisory rate of the one or more other of the plurality of security sensors that are assigned to a second sensor group.

18. The method of claim 12, comprising:
using a trained artificial intelligence model to predict a future time period in which the one or more of the plurality of security sensors is predicted to produce a number of confirmed alarm conditions that is above a threshold, and when so, the security system controller reducing a length of each of the sequential time intervals during the future time period for the one or more of the plurality of security sensors that are precited to produce the number of confirmed alarm conditions that is above the threshold.

19. A method for operating a security system controller, the method comprising:
receiving security sensor alarms from each of a plurality of security sensors in a region of a facility, wherein each security sensor alarm is received when an alarm condition is detected by the corresponding one of the plurality of security sensors;
confirming one or more of the received security sensor alarms when the corresponding security sensor again detects the alarm condition in the region of the facility within a predetermined period of time, resulting in one or more confirmed alarm conditions;
the security system controller issuing an alarm for each of the one or more confirmed alarm conditions;
repeatedly receiving supervisory signals from each of the plurality of security sensors; and
wherein the security system controller has an armed state and a disarmed state, and when the security system controller is in the armed state, the security system controller increases a supervisory rate at which the supervisory signals are to be received from at least some of the plurality of security sensors relative to when the security system controller is in the disarmed state.

20. The method of claim 19, wherein one or more of the plurality of security sensors are assigned to a first sensor group associated with security sensors that are identified as having a higher risk of sensor tampering, and one or more other of the plurality of security sensors are assigned to a second sensor group associated with security sensors that are identified as having a lower risk of sensor tampering relative to the security sensors assigned to the first sensor group, and wherein the security system controller increasing the supervisory rate for the one or more of the plurality of security sensors that are assigned to the first sensor group relative to the supervisory rate for the one or more other of the plurality of security sensors that are assigned to a second sensor group.
